(19) United States
(12) Patent Application Publication
(10) Pub. No.: US 2010/0231394 A1
(43) Pub. Date: Sep. 16, 2010

(54) CARBON MONOXIDE DETECTION AND DISSIPATION APPARATUS

(76) Inventors: Bobby Eugene Finchum, Gastonia, NC (US); David Earl Tomblin, Gastonia, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/401,912

(22) Filed: Mar. 11, 2009

(51) Int. Cl. G08B 17/10

(52) U.S. Cl. 340/632

(57) ABSTRACT

A carbon monoxide detection and dissipation apparatus is provided. The apparatus includes a carbon monoxide detector adapted to detect air-entrained carbon monoxide above a predetermined threshold within an enclosure in detection communication with the carbon monoxide detector, an alarm responsively associated with the carbon monoxide detector for providing an audible signal indicating that the carbon monoxide detector has detected carbon monoxide above the predetermined threshold, and a fan responsively associated with the carbon monoxide detector for exhausting air from the enclosure sufficient to reduce the carbon monoxide to below the predetermined threshold.

### TECHNICAL FIELD AND BACKGROUND OF THE INVENTION

This invention relates to a carbon monoxide detection and dissipation apparatus, and more particularly to a carbon monoxide detection and dissipation apparatus for residential and commercial use.

Carbon monoxide (commonly abbreviated as “CO”) is a deadly, colorless, and odorless gas. In significant quantities, it is also poisonous and is responsible for over 170 residential deaths within the United States each year. Carbon monoxide is produced by burning of fuels, including coal, wood, oil, propane, natural gas, and other fossil fuels. Most of these fuels are used in many types of heat-producing devices. For example fuel-burning appliances such as furnaces, ranges, water heaters and room heaters all produce carbon monoxide. Furthermore, portable generators, fireplaces, and automobiles produce carbon monoxide, and these devices are many times used in an enclosed area where sufficient venting of carbon monoxide is not possible or where through negligence venting, while possible, is not accomplished.

Because carbon monoxide is odorless, colorless, and undetectable to the human senses, exposure is often undetected until a person has experienced dizziness or a headache that may create an awareness that they are experiencing carbon monoxide poisoning. At this point it may be too late to rush the person to safety.

Carbon monoxide detection systems have been used in residential and commercial structures to alert a user that dangerous levels of carbon monoxide have been detected. However, these systems only provide an alert mechanism and fail to include means for reducing or dissipating carbon monoxide levels. Current methods of detecting and extracting dangerous levels of carbon monoxide have not solved these problems.

Accordingly, there is a need for a carbon monoxide monitoring apparatus that includes not only an alert that carbon monoxide is present, but includes a system for dissipating dangerous levels of carbon monoxide.

### SUMMARY OF THE INVENTION

Therefore, it is an object of the invention to provide a carbon monoxide monitoring and dissipating apparatus.

It is another object of the invention to provide a carbon monoxide monitoring and dissipating apparatus that is relatively inexpensive.

It is another object of the invention to provide a carbon monoxide monitoring and dissipating apparatus that provides an alert of dangerous carbon monoxide levels.

It is another object of the invention to provide a carbon monoxide monitoring and dissipating apparatus that continues to operate until carbon monoxide levels are within acceptable ranges.

It is another object of the invention to provide a carbon monoxide monitoring and dissipating apparatus that is portable.

These and other objects and advantages are achieved by providing a carbon monoxide detection and dissipation apparatus. The apparatus includes a carbon monoxide detector adapted to detect air-entrained carbon monoxide above a predetermined threshold within an enclosure in detection communication with the carbon monoxide detector, an alarm responsively associated with the carbon monoxide detector for providing an audible signal indicating that the carbon monoxide detector has detected carbon monoxide above the predetermined threshold, and a fan responsively associated with the carbon monoxide detector for exhausting air from the enclosure sufficient to reduce the carbon monoxide to below the predetermined threshold.

According to another embodiment of the invention, the apparatus further includes a visual signal for indicating that the carbon monoxide detector has detected carbon monoxide above the predetermined level.

According to another embodiment of the invention, the fan continues to exhaust air from the enclosure until reset by a reset switch.

According to another embodiment of the invention, the fan exhausts into the exhaust vent within the enclosure.

According to another embodiment of the invention, the apparatus further includes a power supply for providing power to the alarm and the fan.

According to another embodiment of the invention, the apparatus further includes a backup power supply for supplying power to one of the alarm of the fan.

According to another embodiment of the invention, the apparatus further includes a test button for testing the operability of the alarm or the fan.

According to another embodiment of the invention, the apparatus further includes a reset button for resetting the alarm, the fan, or both the alarm and the fan.

According to another embodiment of the invention, the carbon monoxide detector is mounted in a ceiling joist of the enclosure.

According to another embodiment of the invention, the apparatus is formed from one integral unit.

According to another embodiment of the invention, the apparatus further includes an intake in air flow communication between an exterior of the enclosure and the fan for supplying fresh air from the exterior of the enclosure into the interior.

According to another embodiment of the invention, the fan no longer exhausts air from the enclosure once carbon monoxide levels are below predetermined threshold.

According to another preferred embodiment of the invention, a carbon monoxide detection and dissipation apparatus is provided. The apparatus includes a carbon monoxide detector adapted to detect air-entrained carbon monoxide above a predetermined threshold within an enclosure in detection communication with the carbon monoxide detector, an alarm responsively associated with the carbon monoxide detector for providing a signal indicating that the carbon monoxide detector has detected carbon monoxide above the predetermined threshold, a fan responsively associated with the carbon monoxide detector for exhausting air from the enclosure sufficient to reduce the carbon monoxide to below the predetermined threshold, and a reset switch for resetting the fan or the alarm, wherein the fan continues to exhaust air out of the enclosure until the carbon monoxide is below the predetermined threshold.

According to another embodiment of the invention, the signal is an audible or visual signal.

### BRIEF DESCRIPTION OF THE DRAWINGS

Some of the objects of the invention have been set forth above. Other objects and advantages of the invention will appear as the description of the invention proceeds when taken in conjunction with the following drawings, in which:

FIG. 1 is a cross sectional view of a carbon monoxide detection and dissipation apparatus installed within an enclosure according to the present invention;

FIG. 2 is a cross sectional view of a carbon monoxide detection and dissipation apparatus according to another embodiment of the present invention;

FIG. 3 is a front view of a grill used with the carbon monoxide detection and dissipation apparatus of FIG. 2;

FIG. 4 is a front view of a ceiling cutout for accommodating the grill according to FIGS. 2 and 3;

FIG. 5 is a perspective view of a carbon monoxide detection and dissipation apparatus according to another embodiment of the present invention; and

FIGS. 6 and 7 are schematic views of the operation of the carbon monoxide detection and dissipation apparatus.

### DESCRIPTION OF THE PREFERRED EMBODIMENTS AND BEST MODE

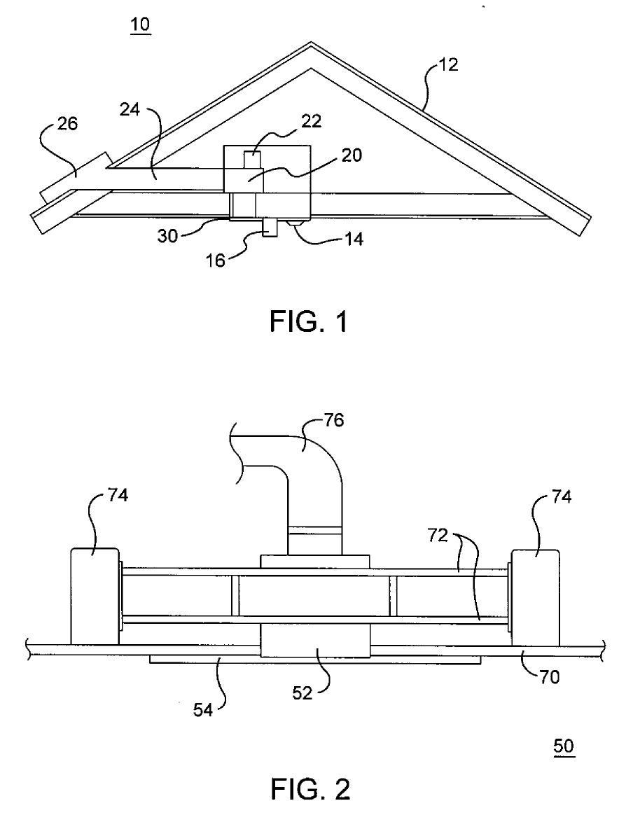

Referring now specifically to the drawings, a carbon monoxide detection and dissipation apparatus according to the present invention is shown in FIG. 1 at reference numeral 10. The carbon monoxide detection and dissipation apparatus 10 is preferably mounted within an enclosure 12. A carbon monoxide detector 14 is adapted to detect air-entrained carbon monoxide above a predetermined threshold within the enclosure 12. The carbon monoxide detector 14 is connected to an alarm 16, which may be a visual alarm such as a strobe light and/or an audible alarm such as a bell, buzzer or horn. A fan 20 is connected to the carbon monoxide detector 14 for exhausting air from the enclosure 12 to reduce the carbon monoxide below the predetermined threshold. An exhaust vent 24 and an exhaust cap 26 on the exterior of the enclosure 12 form an exhaust gas pathway for exhaust gases to flow when the fan 20 is in operation. Fan 20 includes a fan motor 22. A grill 30 provides air communication to the enclosure 12 and may include air breathing openings such as louvers, slots, or honeycomb structures for air flow communications within the enclosure 12. As shown in FIG. 1, the apparatus 10 is positioned to exhaust air through the roof of a building, but it may be appropriate to exhaust air through an eave vent or through a side wall.

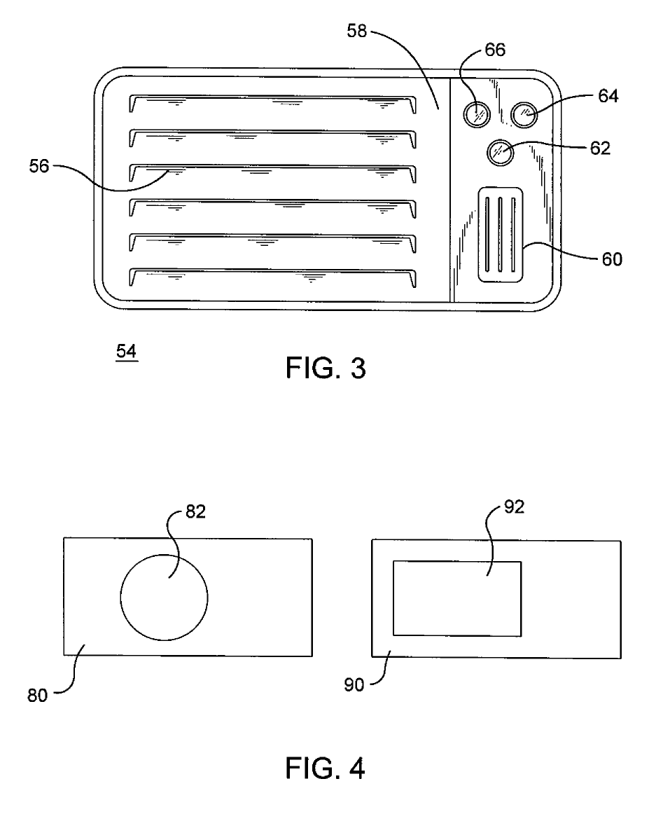

FIG. 2 is a cross sectional view of a carbon monoxide detection and dissipation apparatus 50 according to another embodiment of the present invention. The carbon monoxide detection and dissipation apparatus 50 includes an exhaust fan 52 in communication with a grill 54, which is shown in greater detail in FIG. 3. The exhaust fan 52 is mounted within a ceiling 70 of an enclosure such as a residential dwelling or commercial building. The ceiling 70 includes a conventional ceiling joist 74. A mounting bracket 72 spans each successive ceiling joist 74 and provides mounting support for the exhaust fan 52. An exhaust duct 76 carries exhausted air from the exhaust fan 52 to an exterior of the enclosure 12.

As shown in FIG. 3, the grill 54 includes a plurality of laterally extending spaced-apart louvers 56 that provide fluid communication with a corresponding opening formed in the grill surface. An alarm module 58 is produced internally within the grill 54. An alarm indicator, such as a strobe light, is provided on the grill 54 and is represented as 60. The alarm module 58 is in responsive communication with the alarm indicator 60 to provide an alarm alert when the alarm module 58 determines that carbon monoxide levels are above the predetermined threshold. A test button 62 is provided for testing the operability of the alarm module 58 or exhaust fan 52, an alarm reset button 64 is provided for resetting the alarm module 58, and a fan reset button 66 is provided for resetting the fan 52. The carbon monoxide detection and dissipation apparatus 50 may be programmed such that the fan 52 continues to operate after detecting carbon monoxide levels above the predetermined threshold and will not cut off until instructed to by a homeowner or other appropriate person. This ensures that the fan 52 will continue to exhaust air potentially containing carbon monoxide until the homeowner or other appropriate person determines that the enclosure 12 is safe.

A strobe light 60 provides a visual alert when predetermined thresholds of carbon monoxide have been detected. The alarm reset button 66 functions to also reset the strobe light 60. In preferred embodiments, the strobe light 60 may operate when the fan 52 is in operation, or may be programmable such that it does not continue to operate a predetermined amount of time before or after the fan 52 is cut off.

FIG. 4 represents appropriately sized ceiling cutouts for receiving the grill 54. Cutout 80 has an appropriately sized circular opening 82 for receiving a blade fan type grill 54. Cutout 90 has an appropriately sized rectangular opening 92 for receiving a squirrel cage fan type grill 54. Other appropriately shaped cutouts may be employed as desired. The grill 54 size and appropriate cutout size will be modified as appropriate for differing sizes of target areas.

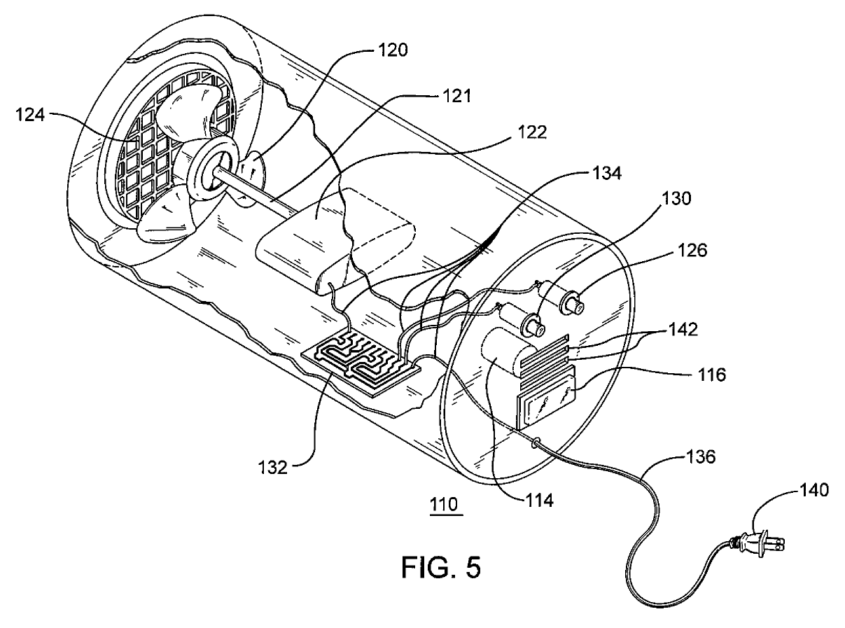

FIG. 5 represents an alternate embodiment of the present invention. A carbon monoxide detection and dissipation apparatus 110 is shown as one integral and portable unit. This apparatus 110 is suitable for being plugged into an electrical outlet and near an outlet or vent to exhaust carbon monoxide. This apparatus 110 is appropriate for residential and commercial use, but may also have applicability as a portable unit for camping or similar activities. This apparatus 110 generally defines a structure that houses a fan blade 120 connected with a fan shaft 121 that is provided rotational power from a fan motor 122. The fan blade 120 is operable to exhaust air through exhaust vents 124 which are depicted in a honeycomb shape but may be slits or any other appropriate configuration. The fan motor 122 is connected by cable 134 to a circuit board 132 that provides electrical power via power cord 136 that communicates with an electrical power source via conventional plug 140. Preferably, the electrical power source will be conventional 110 volt household current. A backup power source such as an internal battery may also be provided. The circuit board 132 is electrically connected via cables 134 that are connected to a carbon monoxide detector 114 positioned near vents 142. The circuit board 132 is also electrically connected via cables 134 to a test button 126 that tests the operability of the fan motor 122 and alarm 116. Alarm 116 may be an LED indicator, strobe light, or may incorporate an audible signal. Reset button 130 is operable to reset fan motor 122 and in preferred embodiments, is the only way to disable the carbon monoxide monitoring and dissipating apparatus 110.

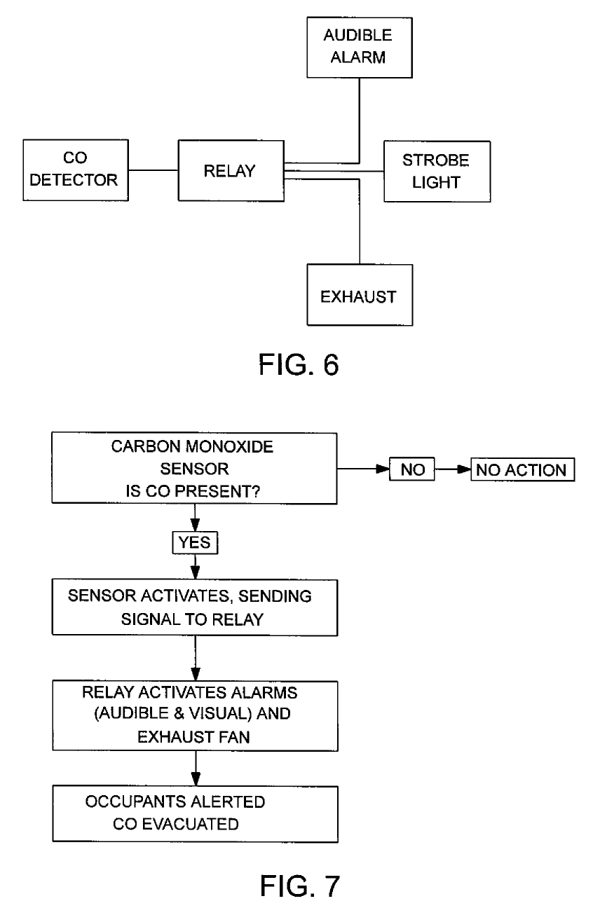

FIGS. 6 and 7 are a schematic representation of the operability of the carbon monoxide monitoring and dissipating apparatuses 10 and 110. As shown in FIG. 6, the carbon monoxide detector communicates with a relay when carbon monoxide levels exceed a predetermined threshold. The relay may be the type that remains on until deactivated by an appropriate reset switch, or the relay may only be operable when carbon monoxide levels exceed the predetermined threshold. The relay is in communication with the audible alarm, strobe light, and exhaust fan, and initiates operation of each of these devices when carbon monoxide levels exceed the predetermined threshold.

In other embodiments, the carbon monoxide detection and dissipation apparatus may further include an intake air vent for providing fresh air from outside of the enclosure 12. This intake air vent may work in coordination with the exhaust vent 24 to simultaneously exhaust air-entrained carbon monoxide while providing fresh air inside of the enclosure 12. In other applications, the apparatus may import fresh air into the enclosure 12 to displace interior air containing the carbon-monoxide while increasing the air pressure within the enclosure 12 to retard further infiltration of carbon monoxide into the enclosure 12, as from a forced-air heating system. In some instances, such as a broken heater leaking carbon monoxide gases, exhausting gases out of the enclosure creates a low pressure system within the enclosure. This low pressure creates a substantial pressure differential between the enclosure and the broken heater, thus increasing the flow rate of carbon monoxide gas from the broken heater to the enclosure. For this reason, it may be desirable to provide fresh air into the enclosure to increase the pressure rate within the enclosure. The present invention is adaptable to exhaust air-entrained carbon monoxide, while also providing fresh air into the enclosure.

A carbon monoxide monitoring and dissipating apparatus is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

We claim:

1. A carbon monoxide detection and dissipation apparatus, comprising:
(a) a carbon monoxide detector adapted to detect air-entrained carbon monoxide above a predetermined threshold within an enclosure in detection communication with the carbon monoxide detector;
(b) an alarm responsively associated with the carbon monoxide detector for providing an audible signal indicating that the carbon monoxide detector has detected carbon monoxide above the predetermined threshold; and
(c) a fan responsively associated with the carbon monoxide detector for exhausting air from the enclosure sufficient to reduce the carbon monoxide to below the predetermined threshold.

2. The apparatus of claim 1, further including a visual signal for indicating that the carbon monoxide detector has detected carbon monoxide above the predetermined level.

3. The apparatus of claim 1, wherein the fan continues to exhaust air from the enclosure until reset by a reset switch.

4. The apparatus of claim 1, wherein the fan exhausts air into an exhaust vent within the enclosure.

5. The apparatus of claim 1, further including a power supply for providing power to the alarm and the fan.

6. The apparatus of claim 5, further including a backup power supply for supplying power to one of the alarm of the fan.

7. The apparatus of claim 1, further including a test button for testing the operability of the alarm or the fan.

8. The apparatus of claim 1, further including a reset button for resetting the alarm, the fan, and combinations thereof.

9. The apparatus of claim 1, wherein the carbon monoxide detector is mounted in a ceiling joist of the enclosure.

10. The apparatus of claim 1, wherein the apparatus is formed from one integral unit.

11. The apparatus of claim 1, further including an air intake vent in air flow communication with an exterior of the enclosure and the fan for supplying fresh air from the exterior of the enclosure into the interior.

12. The apparatus of claim 1, wherein the fan no longer exhausts air from the enclosure once carbon monoxide levels are below the predetermined threshold.

13. A carbon monoxide detection and dissipation apparatus, comprising:
(a) a carbon monoxide detector adapted to detect air-entrained carbon monoxide above a predetermined threshold within an enclosure in detection communication with the carbon monoxide detector;
(b) an alarm responsively associated with the carbon monoxide detector for providing a signal indicating that the carbon monoxide detector has detected carbon monoxide above the predetermined threshold;
(c) a fan responsively associated with the carbon monoxide detector for exhausting air from the enclosure sufficient to reduce the carbon monoxide to below the predetermined threshold; and
(d) a reset switch for resetting the fan or the alarm, wherein the fan continues to exhaust air out of the enclosure until the carbon monoxide is below the predetermined threshold.

14. The apparatus of claim 13, wherein the signal is an audible or visual signal.

15. The apparatus of claim 13, further including a power supply for providing power to the alarm and the fan.

16. The apparatus of claim 15, further including a backup power supply for supplying power to one of the alarm of the fan.

17. The apparatus of claim 13, further including a test button for testing the operability of the alarm or the fan.

18. The apparatus of claim 13, wherein the carbon monoxide detector is mounted in a ceiling joist of the enclosure.

19. The apparatus of claim 1, further including an intake air vent in air flow communication with an exterior of the enclosure and the fan for supplying fresh air from the exterior of the enclosure into the interior.
